(19) United States
(12) Patent Application Publication
(10) Pub. No.: US 2010/0257203 A1
(43) Pub. Date: Oct. 7, 2010

(54) System and Method for Playlist Automation

(75) Inventor: Todd Sun, Marlborough, CT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zatisfi, LLC, South Glastonbury, CT (US)

(21) Appl. No.: 12/754,297

(22) Filed: Apr. 5, 2010

Related U.S. Application Data
(60) Provisional application No. 61/211,789, filed on Apr. 3, 2009.

(51) Int. Cl. G06F 17/30

(52) U.S. Cl. 707/780; 707/825; 707/E17.009; 707/E17.01

(57) ABSTRACT

Systems and methods including electronically scanning a local storage for media files, automatically creating a local media database based on the scan, identifying a playlist, automatically identifying a media file in the local media database corresponding to an element in the playlist, and automatically updating the element in the playlist based on the identified media file.

### CROSS-REFERENCES TO RELATED APPLICATIONS

This application is a non-provisional of U.S. Provisional Application. No. 61/211,789, filed on Apr. 3, 2009, the disclosure of which is hereby incorporated herein by reference in its entirety.

### BACKGROUND OF THE INVENTION

In the digital media market, playlists are important components that facilitate the availability and ease of use of media files located on a electronic device. For instance, in the context of music files, playlists allow a user to save a list of songs that can be easily played many times without having to search for each individual music file. A user can also group particular media files, such as video, audio and/or picture files, together and arrange the order and/or combinations in which they are accessed and played. Thus, playlists have become an important part of using digital media, such as the use of digital video and music files.

However, playlists generally cannot be standardized by adopting a standard file format because a playlist normally includes a specific list of files that are located on a particular device. Thus, the elements in a playlist are not universally applicable, e.g. among different digital media-capable devices. For example, specific file entries for a playlist may include a drive letter, directory or folder names, file names and/or a file extension. Each PC (e.g. personal computer, mobile device, digital media player, portable media player, and any other digital media-capable electronic device) may be unique with respect to where files are stored (drive letters and directory names) and how it is named (filenames and extensions). Thus, solutions for improving the transferability of playlists have proven to be difficult because, in addition to there being no universally accepted digital file identifiers, i.e. no standard identification numbers, naming conventions or other standards that can be relied upon with respect to identifying like media files on different machines, their storage on the host device is also difficult or impossible to predict. This can lead to a number of problems with regard to transferring or copying playlists, and severely limits their utility in the field of digital media.

To share playlists, particularly across different software applications, users currently must either manually edit the playlist or recreate it file-by-file with their digital media player (or other software application) if they want to use a playlist created by another person, device, or application program. As a result, users are limited in their ability to automatically share playlists between different applications, and devices and/or with other users.

### BRIEF SUMMARY OF THE INVENTION

The subject matter of the present invention may have applicability to the sharing of electronic playlists for digital media files. Embodiments of the described systems and methods may also provide for a working playlist created by a user to be automatically modified to work with a different software application and/or a different electronic device.

In the digital media market, PCs are the primary media collection and playback devices. As used herein, PC includes, for example, personal computers, mobile computing devices, digital media players, portable media players, and other digital media-capable electronic devices, such as phones, digital cameras, and the like. An important component used in such devices is the playlist, which facilitates the playback of media files. Although primarily described in the context of digital music playlists, this disclosure also contemplates the use of playlists for other digital media and digital multimedia playlists, such as combinations of digital videos, digital images, other digital audio files, and the like.

A playlist may also include metadata related to such digital media files. Metadata may include additional information about the element of a playlist including, for example: means of creation, purpose of the data, time and date of creation, creator or author of data, placement on a network, where the data was created, the standards used, etc.

Presently, a playlist can be built in a number of different software media players on a PC. In general, users create playlists in the media player of their choice, such as iTunes®, Windows Media Player®, or Winamp® for example.

Generally, playlists include file lists that can only be executed on the PC it was created on, or possibly an identical PC with identical software, files and file structure, because the elements in a playlist include the locations of local files, i.e. each entry identifies not a media item per se to be played, but a file to be loaded, played, and/or executed. Thus, the entries of a playlist present problems when attempting to use the playlist on another device. For instance, the drive letter, file path, and/or file name of a media file corresponding to the playlist element created on one device are likely to be different for the corresponding media file on another device. One reason for this is that PCs can often have more than one hard drive. Other potential causes include, by way of example only, the directories containing the files may be uniquely named, there are no standard naming conventions for the file names, and there are many different software media players and digital media file formats with unique file extensions.

As a result of the above difficulties, there are at least the following exemplary shortfalls in known systems with respect to playlist utility: (1) a user may not be able to use a playlist from a first platform, such as iTunes® in a second platform, such as Windows Media Player®, (2) a user may not be able use a playlist from their personal computer on a second personal computer they also own, (3) a user may not be able use a playlist from their personal computer on another digital media-capable electronic device, (4) a user may not be able to use a playlist from a portable media player, such as an iPod®, in a different brand portable player, such as a SanDisk®, (5) a user may not be able to share their playlist with others by uploading and allowing another to download only the playlist (e.g. an M3U or other playlist file), and (6) a playlist from another device, personal computer, software platform, or user may not be able to be used automatically.

In view of foregoing, it would be desirable to provide systems and methods wherein playlists can be shared in their native file format and automatically edited or modified to provide similar functionality on a PC (or any other digital media playback platform) that is different than the original that was used to create the playlist. In particular, embodiments of the present invention may include systems and methods that can automatically replace or modify the elements in a playlist with a fully qualified path, filename, file extensions, or other information.

Embodiments of the present invention may also parse an element of a playlist and compare the parsed components against a database of files. For example, a database corresponding to music files may store information for each entry related to artist and song title. Embodiments of the present invention may parse this element in the playlist (i.e. the file paths for each song file or from meta-data corresponding to each file) and identify this related information. Embodiments may then compare the parsed information to the stored database. Other components beside artist and song title may be chosen, as appropriate, for different types of digital media files, i.e. the components may be based on the type of digital media file. For instance, for digital movie files the information may include the title and the starring actors, digital images may include a creating device ID and timestamp, etc.

Embodiments of the present invention may include electronically scanning a local storage for media files, automatically creating a local media database based on the scan, identifying a playlist, automatically identifying a media file in the local media database corresponding to an element in the playlist, and/or automatically updating an element in the playlist based on the identified media file.

Embodiments may include automatically updating an element in the playlist by changing a file identifier of the playlist to a second file identifier that corresponds to a media application that the playlist was not created by, is located on a device that the playlist was not created on, or corresponds to a new file location on a device that the playlist was created on.

Embodiments may include electronically querying an identification database based on the element in the playlist and receiving information from the identification database corresponding to the element in the playlist. Automatically identifying a media file in the local media database may include utilizing the received information from the identification database. In embodiments, the identification database may be a local identification database and may be customized based on user preferences, media popularity, or combinations thereof. In embodiments, the identification database may be a master identification database.

In embodiments, querying the identification database may include querying a first identification database based on the element in the playlist. If a first match of the element in the playlist is identified in the first identification database, information corresponding to the first match may be used as the received information for automatically identifying a media file in the local media database. If a first match of the element in the playlist is not identified in the first identification database, a second identification database may be queried based on the element in the playlist, and information corresponding to a second match of the element in the playlist in the second identification database may be received. The information corresponding to the second match may be used as the received information for automatically identifying a media file in the local media database. In embodiments, the first identification database may be a local identification database, and the second identification database may be a remote identification database.

Embodiments may include automatically identifying a media file in the local media database by utilizing information from an identification database, wherein the information was obtained by an electronic query of the identification database based on an element in the playlist.

In embodiments, the electronic query of the identification database may include querying a first identification database based on an element in the playlist. If a first match of the element in the playlist is identified in the first identification database, information corresponding to the first match may be used as the received information for automatically identifying a media file in the local media database. If a first match of the element in the playlist is not identified in the first identification database, a second identification database may be queried based on the element in the playlist, and information corresponding to a second match of the element in the playlist in the second identification database may be received. The information corresponding to the second match may be used as the received information for automatically identifying a media file in the local media database.

Embodiments may include an electronic storage device including stored media files, and a media collection scanning module. In embodiments, the scanning module may be configured to scan the storage device, identify the stored media files, and/or create a local media database. Embodiments may include a playlist module that is configured to identify a playlist, and a match module that is configured to match an element in the playlist with a media file in the local media database. Embodiments may include a move module configured to move the playlist to an appropriate storage location for either a media application that the playlist was not created by or a device that the playlist was not created on.

Embodiments may include the match module configured to match an element in the playlist with a media file in the local media database based on information received from an identification database. Embodiments may include an identification database that may be an Internet or Intranet-based master database or a local identification database. Embodiments may include the match module being configured to match an element in the playlist with a media file in the local media database based on standardized identification information in the identification database.

Embodiments may include the match module being configured to query a local identification database based on the element in the playlist. If a first match of the element in the playlist is identified in the local identification database, then information corresponding to the first match may be used to match the element in the playlist with a media file in the local media database. In embodiments, if a first match of the element in the playlist is not identified in the local identification database, a master identification database may be queried based on the element in the playlist, and a second match of the element in the playlist in the master identification database may be identified. Information corresponding to the second match may be used to match the element in the playlist with a media file in the local media database.

In embodiments, the playlist module may be configured to standardize a non-standard formatted playlist element and/or to parse a standardized playlist element. In embodiments, the match module may be configured to match a component of a playlist element to a media file in the local media database. The match module may be configured to match a playlist element having errors to a media file. Such errors may include, for example, incomplete artist and song title, incomplete component of playlist element, misspellings, typos, transpositions, abbreviated spellings, acronyms, or combination thereof. In embodiments, the match module may be configured to match a playlist element that has a missing or incorrect internal tag to a media file. The match module may be configured to edit a playlist element, for example, so that the element matches a local media file to the drive letter, fully qualified path, file name, extension, or combinations thereof. In embodiments, the match module may be configured to edit a playlist entry to include an indicator that the entry does not match a local media file, and/or the move module may be configured to only move playlist entries that match a corresponding local media file.

Embodiments may include a computer-readable storage medium bearing instructions that, when executed by a computer, cause the computer to perform automated functions described herein, such as causing the computer to scan a local storage for media files, create a local media database based on the scan, identify a playlist, and query a local identification database based on an element in the playlist. In embodiments, if a first match of the element in the playlist is identified in the local identification database, then the local media database may be queried by a computer processor based on information in the local identification database that corresponds to said first match, and media files may be automatically identified in the local media database that correspond to the information in the local identification database that corresponds to the first match. In embodiments, if a first match of the element in the playlist is not identified in the local identification database, a master identification database may be queried by a computer processor based on the element in the playlist, and a second match of the element in the playlist in the master identification database may be automatically identified. The local media database may be queried by a computer processor based on information received from the master identification database that corresponds to the second match, and media files in the local media database that correspond to the information received from the master identification database may be automatically identified. Embodiments may also include computer-readable storage medium bearing instructions that, when executed by a computer, cause the computer to update the playlist element based on the identified media files and change a file identifier of the playlist to a second file identifier that corresponds to a media application that the playlist was not created by, or is located on a device that the playlist was not created on.

Embodiments may include a computer-readable storage medium comprising instructions that when executed by a computer cause the computer to send an exception code and the element of a playlist to an exception database if a first match of the element in the playlist is not identified in the local identification database and a second match of the element in the playlist is not identified in the master identification database. In embodiments, the instructions may cause a computer to provide an option to purchase a media file if a second match of the element in the playlist is identified in the master identification database but no media files are identified in the local media database that correspond to information received from the master identification database that corresponds to the second match. In embodiments, the instructions may cause a computer to provide a report to a user of how many of the elements of a playlist were identified in the local media database, how many of the elements of the playlist were not identified in the local media database, or a combination thereof. As described in exemplary manner further below, embodiments may also include additional instructions, which may be included on a computer-readable storage medium, for causing a computer to perform automated steps and methods related to uploading, downloading, and/or modifying playlists used by computing devices.

Further advantages of the present subject matter will become apparent to those of ordinary skill in the art upon reading and understanding the following detailed description of the preferred embodiments.

### BRIEF DESCRIPTION OF THE DRAWINGS

FIG. 1 depicts a table showing different file naming examples using various software platforms that may be utilized to create playlists;

FIG. 2 depicts aspects of an exemplary embodiment including a server;

FIG. 3 depicts aspects of an exemplary embodiment of a computing device;

FIG. 4 depicts aspects of an exemplary embodiment of a system that contains modules that may perform functions or processes in accordance with the present invention;

FIG. 5A depicts aspects of an exemplary embodiment of a system module that may perform functions or processes in accordance with aspects of the present invention;

FIG. 5B depicts aspects of an exemplary embodiment of modules that may perform functions or processes in accordance with aspects of the present invention;

FIG. 6 depicts aspects of databases that may be local for an exemplary embodiment of the present invention;

FIG. 7 depicts aspects of databases that may be remote for an exemplary embodiment of the present invention;

FIG. 8 depicts aspects of an exemplary embodiment of a system comprising web components and PC components that may perform functions in accordance with the present invention;

FIG. 9 depicts aspects of an initiation process in accordance with an exemplary embodiment of the present invention;

FIG. 10 depicts aspects of a download process in which a playlist is automatically edited in accordance with an exemplary embodiment of the present invention;

FIG. 11 depicts a flow chart of a playlist modification process that may be executed in accordance with aspects of an exemplary embodiment of the present invention;

FIG. 12 depicts a flowchart including aspects of an exemplary embodiment of the present invention that may utilize two databases to modify a playlist;

FIG. 13 depicts a flowchart illustrating aspects of a process for downloading a playlist in accordance with an embodiment of the present invention;

FIG. 14 depicts a flowchart illustrating aspects of an upload process of a playlist in accordance with an embodiment of the present invention; and

FIG. 15 depicts screenshots illustrating a user interface for an application program in accordance with aspects of an exemplary embodiment of the present invention.

### DETAILED DESCRIPTION OF THE INVENTION

The following detailed description is provided with reference to exemplary embodiments for the ease of description and understanding. Applicants' invention is not limited to the disclosed embodiments, and encompasses other variations that fall within the overall scope of description provided herein.

The disclosed systems and methods are related to automatically modifying, editing, and/or creating playlists that may be used on personal computing devices of various kinds, digital media players and other digital media-capable electronic devices, mobile devices, and other related digital electronic devices (henceforth these devices will be referred to collectively as “PCs”). The systems and methods may be applicable to, for example, digital media playlists that have been downloaded (e.g. from a server) or side loaded (e.g. between two local devices). The disclosed systems and methods may convert a playlist from a first format to a second format so that it can be utilized by another electronic device or software platform. Examples of instances when a conversion may be required include uploading a playlist to a social network for sharing with others, downloading a playlist from a social media or other website, transferring a playlists from one PC to another PC, and converting a playlist from its present format to another format that is compatible with other digital media software or other hardware configurations located on the same PC or on a different PC. There may be other instances when this conversion may either be required or preferred.

Embodiments of the present systems and methods may utilize databases and a unique identification system to permit media files referenced as elements in a playlist to be individually identified across different PCs and by different digital media software programs. Systems and methods in accordance with the present subject matter may also include functions related to standardizing a playlist into a form that permits easier recognition of the referenced media file. For instance, a music file may be parsed and standardized to identify component fields such as Artist and Song Title.

According to embodiments, each element in a playlist may be identified by querying an identification database or databases utilizing components of a playlist entry, the file names of the elements themselves, or other identifying information (including any information extracted from related metadata). When a playlist entry is matched to a stored media file entry on an Identification Database, information corresponding to that match may be returned to the system, program or component performing the matching function. This information, which may be a unique identifier for that particular media file, may then be used to automatically identify a Local Media File 801 in a Local Media Database 603. The Local Media Database 603 may comprise local digital media files located on the PC and corresponding identification information. The playlist may then be modified with the file location of the identified media file, or a new playlist may be created consisting of local file locations that were matched in this process.

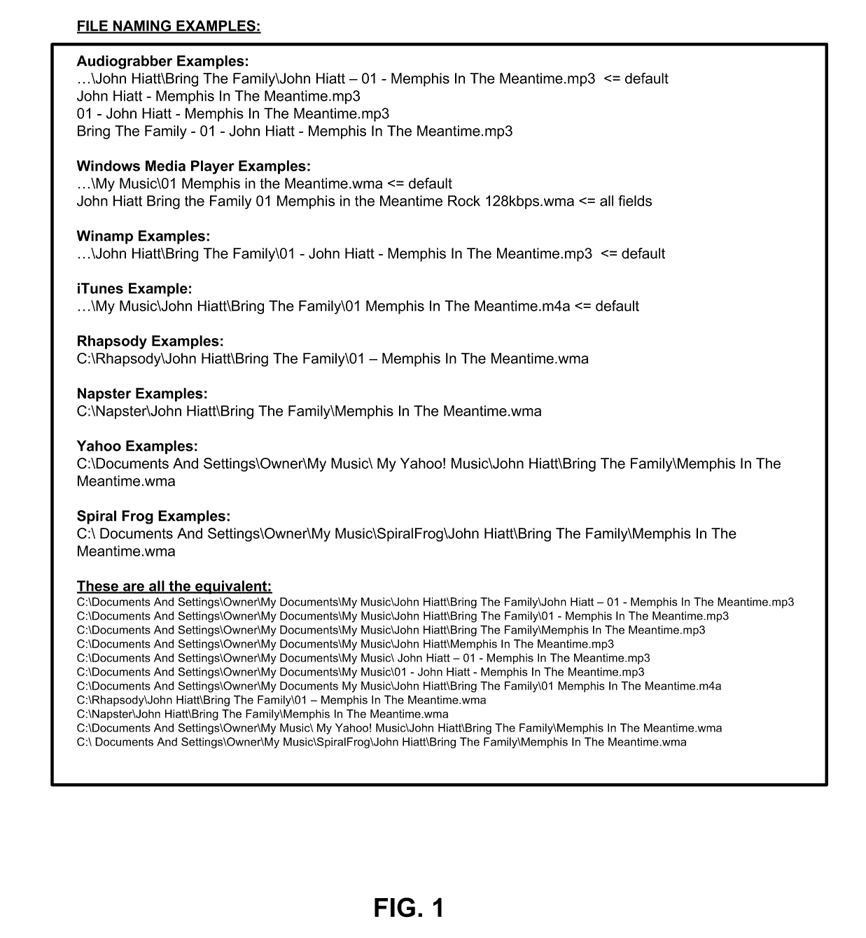

FIG. 1 depicts several different formats that media file names may be comprised of when utilizing different digital media platforms. In this example, all of the filenames are for the same media file, the song Memphis in the Meantime by John Hiatt. However, because a playlist is only a listing of the file name, if a playlist is created on one of the platforms, attempting to use a different platform or PC to automatically use the playlist will be difficult. According to embodiments, each of these files may be identified or correlated with a single media file.

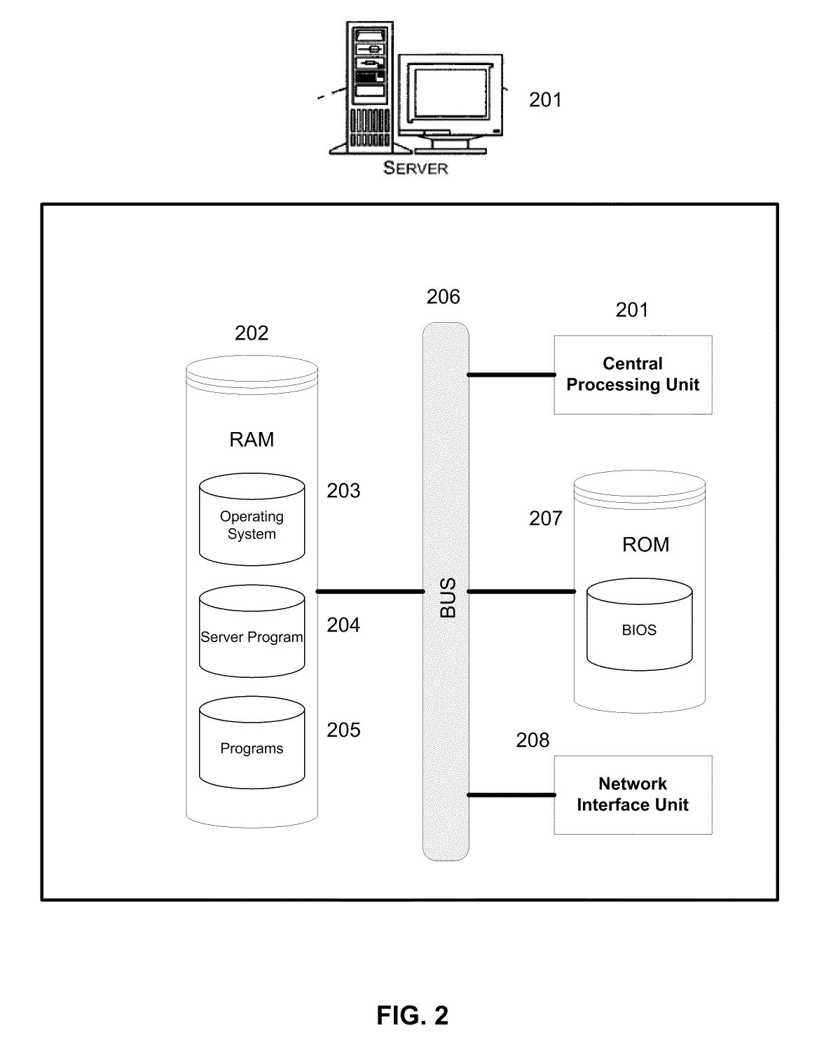

FIG. 2 depicts aspects of a non-limiting exemplary server as discussed herein. As depicted in FIG. 2, a computer server 201 may include a central processing unit 201 that is typically configured to execute functions according to instructions stored in random access memory (RAM) 202 and/or read-only memory (ROM) 207. Additional program instructions, data and the like may be stored and accessible by the CPU 201 in other local or networked storage devices. RAM 202 may variously include instructions for a server operating system (OS) 203, server programs 204 and/or other programs 205, and the like. Individual elements of the server 201 may be interconnected by a bus 206, and may be connected to other servers and/or client devices through various network interface(s) 208.

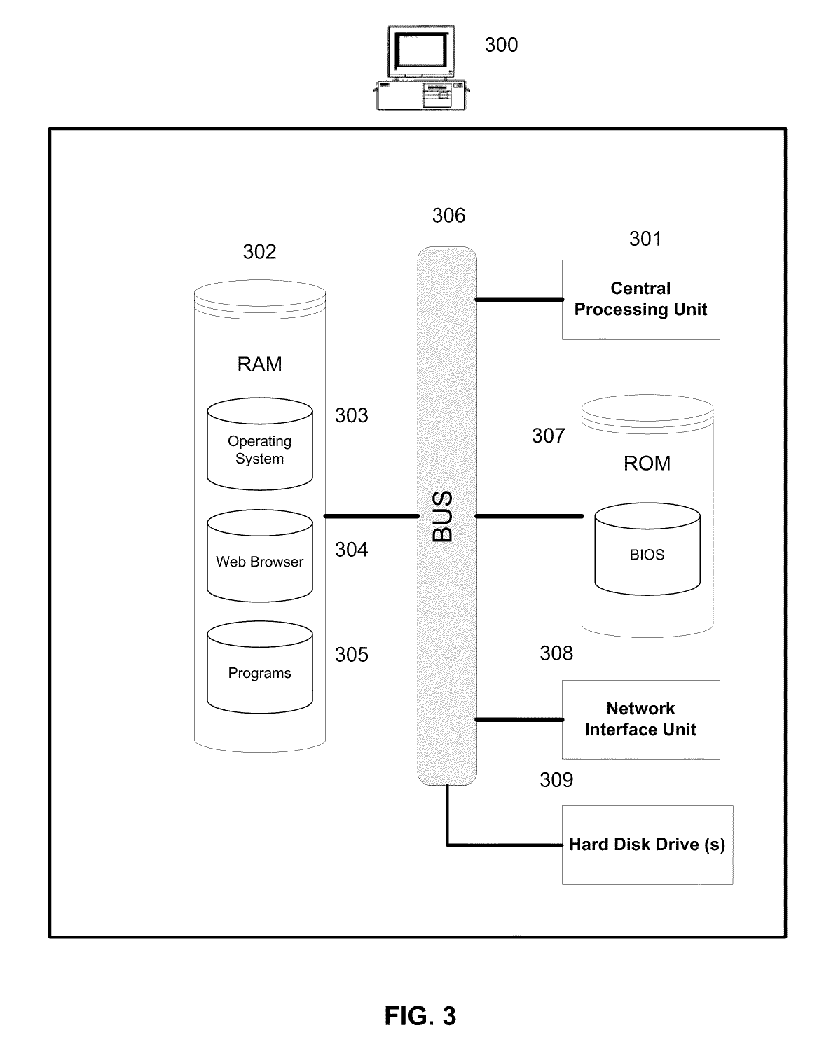

FIG. 3 depicts aspects of a non-limiting exemplary computing device as discussed herein. As depicted in FIG. 3, a computing device 300 may include a central processing unit 301 that is typically configured to execute functions according to instructions stored in random access memory (RAM) 302 and/or read-only memory (ROM) 307. Additional program instructions, data and the like may be stored and accessible by the CPU 301 in other local or networked storage devices, such as a hard disk drive 309. RAM 302 may variously include instructions for a server operating system (OS) 303, web browser 304 and/or other programs 305, such as digital media players, and the like. Individual elements of the computing device 300 may be interconnected by a bus 306, and may be connected to other computing devices and/or servers through various communication/network interface(s) 308.

As discussed herein, computing devices, such as computing device 300, may be configured by program instructions stored on computer readable storage media to perform specialized functions related to creating, uploading, downloading, and modifying digital media playlists. For example, as shown in FIG. 3, computing device 300 may be configured to upload and/or download playlists with servers and/or other computing devices via. communication/network interface(s) 308. The computing device 300 may represent a user computer system, wireless communication devices, or other digital media-capable device with the requisite functional capabilities.

The computing device 300 may include any number of processors including for example, CPU 301, graphics processing units (GPUs), and the like. Storage devices may include any suitable type of the computer-readable media described and/or mentioned above. A mass storage device such as hard disk drive 309 may also be used to store programs, data and the like and is typically a secondary storage medium. It will be appreciated that the information retained within the mass storage device, may, in appropriate cases, be incorporated in standard manner as part of primary storage as virtual memory. A specific mass storage device such as a CD-ROM may also pass data unidirectionally to the processor.

The computing device 300 may also include an interface that includes one or more input/output devices such as such as video monitors, track balls, mice, keyboards, microphones, touch-sensitive displays, transducer card readers, magnetic or paper tape readers, tablets, styluses, voice or handwriting recognizers, or other known input devices, including other computers. The computing device 300 may be coupled to a computer or other electronic communication network using a network connection as shown generally at 308. The network can connect various wired, optical, electronic and other known networks to exchange information among computing devices, servers, wireless communication devices and sub-networks. With such a network connection, it is contemplated that the system and the processor therein may receive information from the network, or may output information to the network in the course of performing the described method steps. The above-described devices and materials will be familiar to those of skill in the computer hardware and software arts and need not be individually or exhaustively depicted to be understood by those of skill in the art. The hardware elements described above may be configured (usually temporarily) to act as one or more modules for performing the operations described herein.

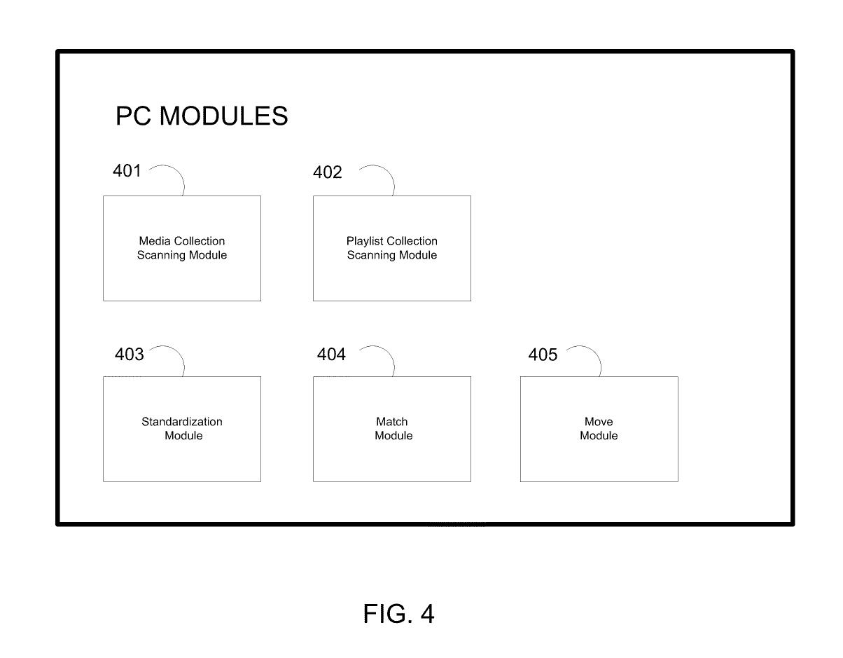

FIG. 4 illustrates an exemplary embodiment of a system, and specifically PC platform that may perform functions in accordance with aspects of the present invention. This system may for example, through the use of software instructions and/or hardware configurations, perform some or all of the functions and steps described below. It should be noted that although this figure illustrates all of the modules located on a single device, the disclosure is not meant to be so limited. A digital media device may have additional components or less then all of these components. Additionally, some modules could be located on other devices such as a remote server or other local devices that are functionally connected to the PC component(s).

The Media Collection Scanning Module 401 may be configured or programmed to scan local memory, such as a local hard drive(s), and create a Local Media Database 603. The Local Media Database 603 may then be used to match a playlist to the local media files. This module may be used to initially create the Local Media Database 603, and also to update the database periodically, upon request, or based on an event. An event may include, for example downloading a playlist from a remote server or side-loading a playlist from another local device.

The Playlist Collection Scanning Module 402 may be configured or programmed to scan local memory, such as a local hard drive(s), and create a Local Playlist Database 602. The Local Playlist Database 602 may then be used to access and manage the playlists stored locally. This module may be used to initially create the Local Playlist Database 602, and also to update the database periodically, upon request, or based on an event. An event may include, for example downloading a playlist from a remote server or side-loading a playlist from another device.

The Standardization Module 403 may be programmed or otherwise configured to convert a playlist from a first format to a second format that is standardized. The second format or standardized playlist may be locally stored (such as in the Local Playlist Database 602) or may be stored remotely (such as in a Master Playlist Database 702). The second format may be more easily and readily used by the Match 404 and Move 405 Modules, described below. Standardization may be used, for instance, when a playlist is side-loaded, after a new playlist but before it is uploaded to a remote server (such as a playlist sharing service), after a playlist has been transferred to a new playlist but before the elements are matched to local media files, or at another point in the process. The Standardization Module 403 may also be used on playlists that are downloaded but have not previously been converted to a standardized format.

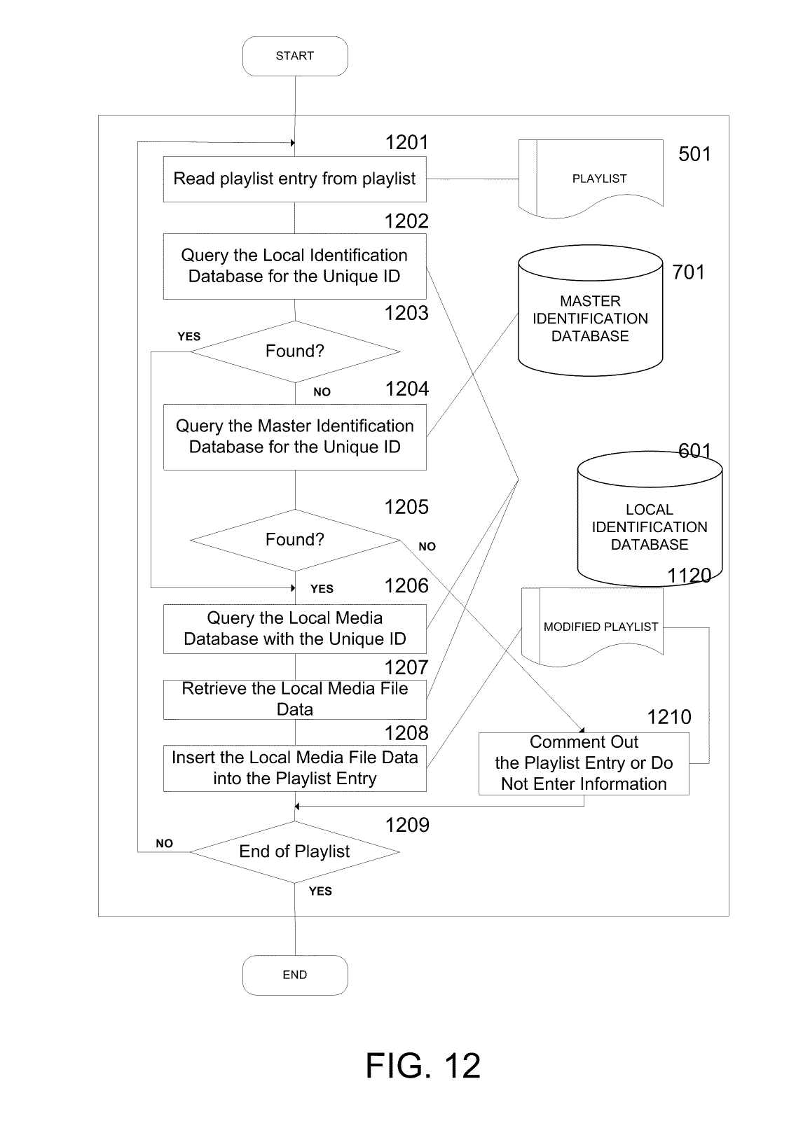

The Match Module 404 may be configured or programmed to match a playlist to the Local Media Files 801. Some functionality that may be performed by this module is also described in the flowcharts in FIG. 11-12. The Match Module 404 may parse a playlist in order to determine pre-designated data of significance, such as, taking the example of digital music files, the artist and song title for each entry in the playlist. The Match Module 404 may parse each entry in a playlist and then utilize this information (or components thereof) to query an Identification Database 1010 (such as a Local 601 or Master 701 Identification Database) for a corresponding match. In the context of digital music files, a Local 601 or Master 701 Identification Database may comprise Artist and Song Title Databases. If a match is found, the Match Module 404 uses information retrieved or received from the Identification Database 1010 corresponding to that digital media file to query the Local Media Database 603. The information received from the Identification Database 1010 may include a unique identifier.

In alternative embodiments, both a Local 601 and a Master (701) Identification Database may be utilized by the Match Module 404. In such embodiments, the Match Module 404 may parse each entry in a playlist by reading the line entry and then query the Local Identification Database 601 with this parsed information to identify a match. Other information related to the playlist entry may also be used to query the database. If a match is found, the Match Module 404 may use reference information received from the database that corresponds to that matched file to query the Local Media Database 603. This reference information may include a unique identifier for the media file. If there is a corresponding match found in the Local Media Database 603 based on the information received from the Local Identification Database 601, the Match Module 404 may edit the playlist element by inserting the file fully qualified string into the playlist at this entry. This may include the drive letter, the fully qualified path, the file name, the file extension, or combinations thereof.

If a match was not found in the Local Identification Database 601, the Match Module 404 may be configured to query the Master Identification Database 701 using the parsed information. Other information related to the playlist entry may also be used to query the database. If a match is found, the Match Module 404 may use reference information corresponding to that match received from the Master Identification Database 701 to query the Local Media Database 603. If there is a corresponding match found in the Local Media Database 603 based on the information received from the Master Identification Database 701, the Match Module 404 may edit the playlist element by inserting the file fully qualified string into the playlist at this entry. This may include the drive letter, the fully qualified path, the file name, the file extension, or combinations thereof.

If a match is not found in either the Local 601 or Master 701 Identification Database, the Match Module 404 may send an exception code and the original playlist entry to an Exception database (which may include a Local 604 or Master 704 Exception Database).

If a match for an element in a playlist is found in either the Local 601 or Master 701 Identification Database, but the corresponding media file is not matched in the Local Media Database 603, the Match Module 404 may send an exception code and the original playlist entry to a Local 604 and/or Master 704 Exception Database. Alternatively, the system may be configured to present the user with an option to purchase the media file. The option to purchase may include all playlist elements not matched in the Local Media Database 603 or just a portion thereof. The option to purchase may be periodic, based on media files that were not matched in previous attempts, or may be predicated on an event (such as the failure of the match module to match a playlist element in the Local Media Database 603).

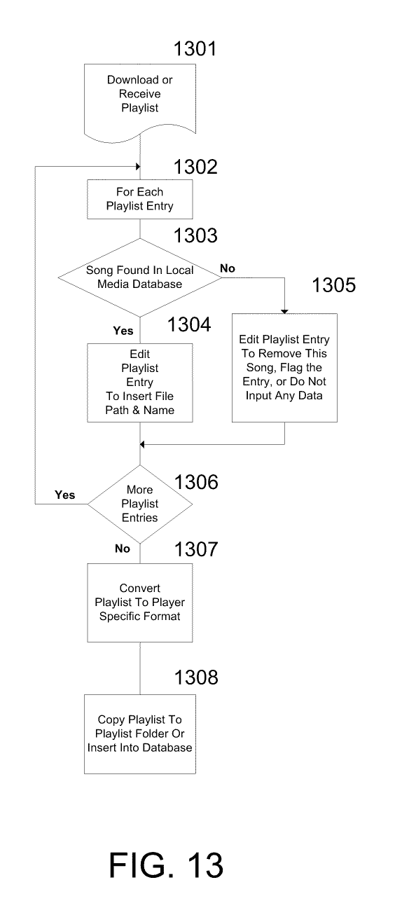

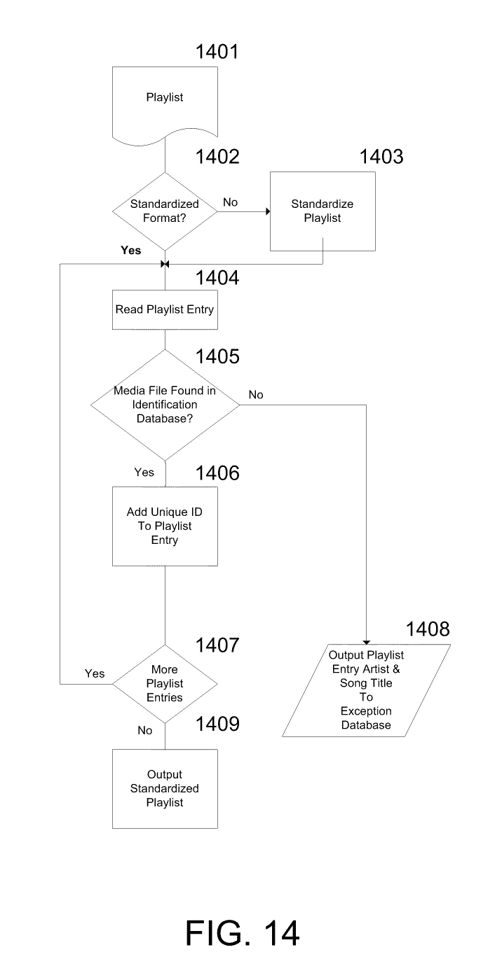

In another embodiment, the Match Module 404 may receive a playlist that has already been modified with information from an Identification Database 1010. For instance, the playlist may have entries that contain only a unique identifier for the corresponding media file or a combination of a unique identifier and other information, with the unique identifier capable of being parsed by the Match Module 404. This may result in circumstances where the PC or electronic computing device that was utilized to create the playlist also performs the queries of the Identification Database or Databases 1010 based on an element in the playlist, and then modifies the playlist entries based on the identified matches and received information. An example of such an embodiment is discussed with reference to FIGS. 13 and 14. The modified playlist may then be transferred (downloaded, side-loaded or any other manner of transferring an electronic playlist) to another PC. The PC, or the Media Collection Scanning Module 401 located or programmed on the PC, may then create the Local Media Database 603 (if the Module has not created and stored one previously). The Match Module 404 may then utilize the unique information in the playlist that was transferred to directly match with media files in the Local Media Database 603. Thus, in embodiments, the querying of the Identification Database 1010 may not have been performed by the computing device that automatically created the local media database based on a scan of the local storage.

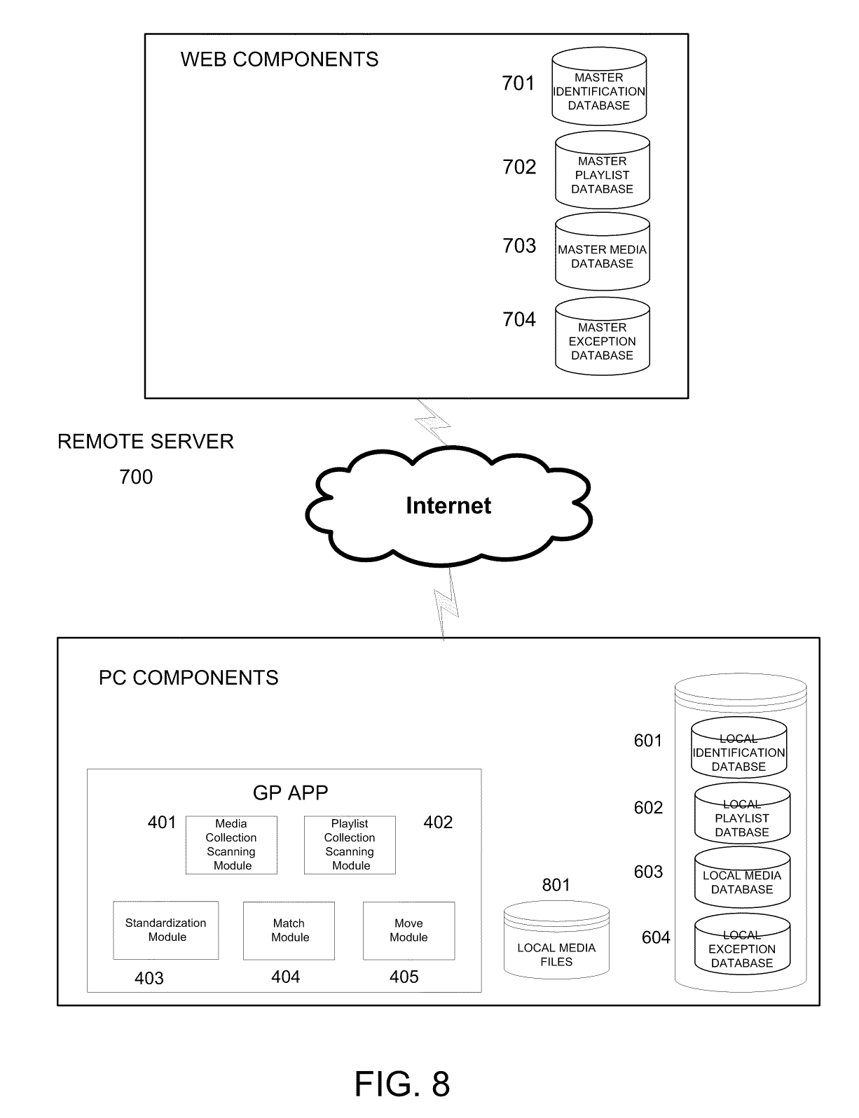

Alternatively, the modification of the playlist with information from an Identification Database 1010 (such as a unique identifier) may be performed at a Remote Server 700, such as shown in FIG. 8. Thus, an originating or third party PC may create a Playlist with elements corresponding to a file location. This playlist may be uploaded to a Remote Server 700. At the Remote Server 700 a similar function is performed to that of the Match Module 404. An Identification Database 1010 (such as Master Identification Database 701) may be queried based on elements in the playlist. If there is a match, the playlist may be modified by including information returned from the Identification Database 1010 related to the match. The modified playlist may be stored in a Playlist Database, such as the Master Playlist Database 702. This modified playlist may then be downloaded by a PC. The PC, or the Media Collection Scanning Module 401 located or programmed on the PC, may then create the Local Media Database 603 (if the Module has not created and stored one previously). The Match Module 404 would then utilize the unique information in the playlist that was downloaded to determine matches with media files in the Local Media Database 603. Thus, in embodiments, the querying of the Identification Database 1010 may not have been performed by the computing device that automatically created the local media database based on a scan of local storage.

The output of the Match Module 404 may be a “matched” standardized playlist, which may be stored in the local playlist database. The matched standardized playlist may include a playlist that contains the local file locations of the relevant media files on a particular PC.

As noted above, the input to the Match Module 404 may be standardized playlist with reference information corresponding to a match in an identification database. For instance, the playlist entries may already be matched to a corresponding unique identifier. In this embodiment, the Match Module 404 may need only query the Local Media Database 603 with the reference information (e.g. unique identifier), rather than performing a query of an Identification Database 1010.

A Search Algorithm may be internal to the Match Module 404. The search algorithm may be configured or programmed to use different approaches depending on the type of file, the amount of data available, the quality of data available, and time allowed by the user for matching. Type of file may be used to determine if all of the necessary information is in the file title or if there is additional information, such as internal file tags, that can be searched. Quantity of data may represent whether there are internal file tags and if there are more than one set. Quality of data may represent whether the data is complete and correctly spelled or if some data is missing and/or misspelled. Time allowed for matching may represent whether the user has selected a quick scan versus a slower more complete scan of their media files. Combinations of these factors may be used by the Match Module 404 in performing the matching. Alternatively, the Search Algorithm may also be a component of a Remote Server 700 (or a remote server may be so programmed or there may be computer readable instructions that when executed, cause it to perform the functions) in embodiments that utilize a Master Identification Database 701. In such embodiments, the element of a playlist (or parsed information) may be transferred to the remote server, which may perform the matching based on a Search Algorithm. If there is a match, the Remote Server 700 may return the corresponding information (e.g. unique identifier) to the PC.

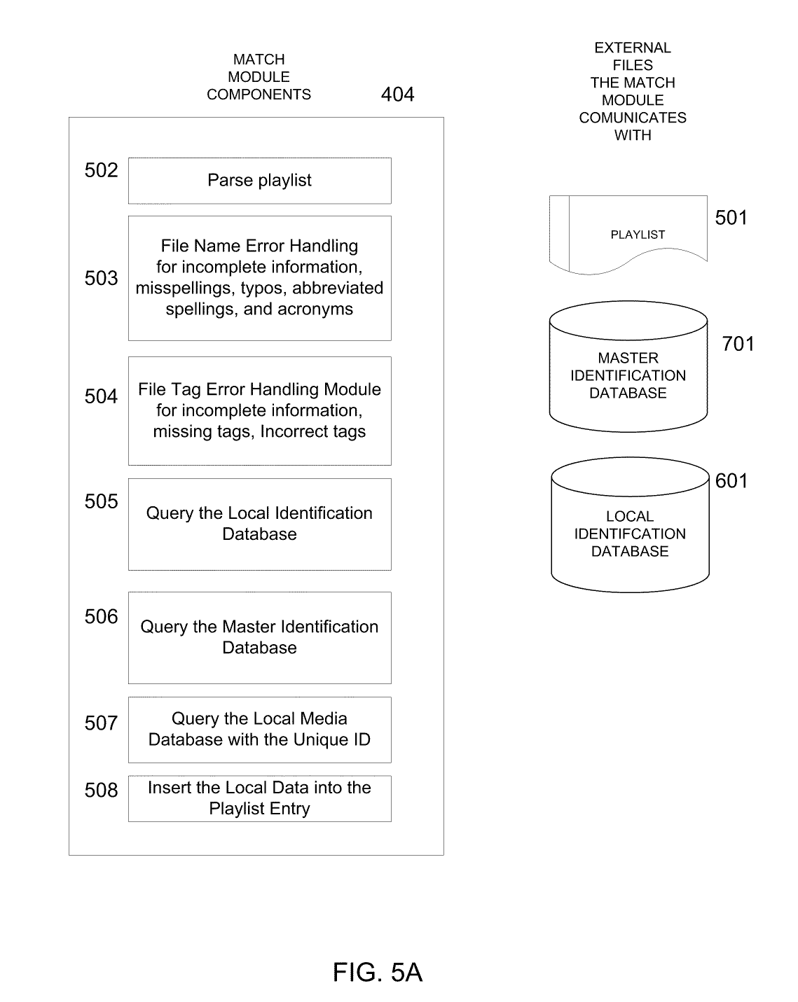

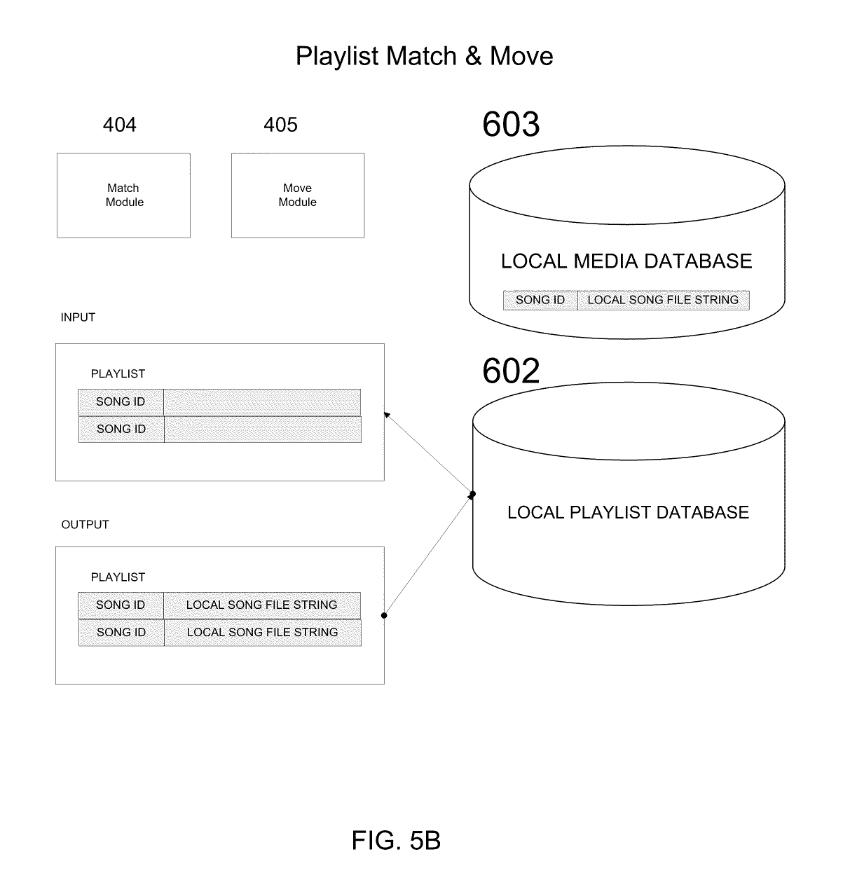

Some digital media files have internal tags while other formats do not. Even if the files have tags, there may be no data, little data, flipped data, or inaccurate data. Although, for instance, many MP3 files are named either artist-track name or track number-artist name-track name, there is no standard to file naming and this cannot generally be relied on. “File rippers” may have defaults, or be customizable by the users, that change, add and/or remove file parameters like album name, genre, year of release, and the like. The Match Module 404, such as shown in FIGS. 5A and 5B, may use algorithms designed to parse both file names and file tags and to reconcile any differences and dependably identify the desired information, such as artist and song title, despite the aforementioned errors. The Match Module 404 may use both a specialized algorithm and a database of tag information, such as artist and song titles, to perform this task.

The Move Module 405 may be configured or programmed to “move” the matched playlist to where the digital media player needs it to be so it can be played. “Moving” the playlist may include creating a copy of the playlist in a particular file format or database entry to a file format compatible with a particular software application and moving the playlist file to a required storage location for a particular software application. The Move Module 405 may provide this function without the user having to know such information or to perform manual inputs or moving instructions. Thus, the matching and moving of the playlist may both be accomplished automatically, without the user having to specifically direct the operations or know complex formatting issues such as where a particular application requires the playlist to be. Thus, the playlist may automatically be converted to the necessary format required by the playback device or software, and then automatically moved to a specific folder or into a database. In embodiments, the playlist may be moved to where the digital media software keeps all other playlists. Additionally, elements in a playlist that could not be matched may be excluded from the playlist that is moved by the Move Module 405 to the appropriate directory for an application. In embodiments, such unmatched elements may remain in a Local Playlist Database 602, and may be used at a later time such as a subsequent matching search or re-initialization of the playlist upon the acquisition of a matching file, e.g. if the user purchases a song matching the previously unmatched playlist element.

It should be appreciated that, by working together, the claimed match and move modules create a synergy that goes beyond the capabilities of the individual elements working alone, and provide capabilities not present in conventional methods of editing or attempting to share playlists. For example, for reasons discussed herein, moving an unmatched playlist to a folder associated with a particular software application would not in and of itself provide an operable playlist for the software application, even if the software recognized the general format of the playlist and the playlist's location. Likewise, matching playlist elements with local media files would not in and of itself create a playlist that is operable by a particular software application. However, by providing a standardized method of matching playlist elements to local media files, along with methods of automatically converting a standardized playlist for effective use with various software applications, the shortfalls in each circumstance may be overcome.

FIG. 5A depicts individual components of the Match Module 404 for a particular embodiment of the present invention. The Match Module 404 need not have all of these components, but may have combinations thereof. The Parse Playlist Component 502 may parse each entry in a playlist by reading the line entry, which information may then be used query the Local Identification Database 601. Alternatively, the parse information component may parse other information, such as a unique identifier for an element of a playlist, or any meta-data that corresponds to the file.

The File Name Error Handling Component 503 may be configured or programmed to accurately match elements in a playlist that have incomplete information, misspellings, typos abbreviated spellings, and acronyms in the file names. Alternatively or congruently, this component may present the user with a list of possible matches for a playlist element, and permit the user to then manually select the correct media file. The File Tag Error Handling Module 504 may be configured or programmed to accurately match elements in a playlist that have incomplete information, misspellings, typos abbreviated spellings, and acronyms in the internal file tags. Alternatively or congruently, this component may present the user with a list of possible matches for a playlist element, and permit the user to then manually select the correct media file.

The Query the Local Identification Database Component 505 may be configured or programmed to query a Local Identification Database 601 based on an element of the playlist. In particular, the query may be based on information that was parsed from the file name, from internal file tags, or any other information corresponding to the element in the playlist. If this module determines that there is a match, the information corresponding to the media file is returned (e.g. a unique identifier for the media file is returned). This unique identifier may used to modify the playlist element and/or utilized by the Query the Local media Database Component 507.

The Query the Master Identification Database Component 506 may be configured or programmed to query a Master Identification Database 701 based on an element of the playlist. In particular, the query may be based on information that was parsed from the file name, from internal file tags, or any other information corresponding to the element in the playlist. This component may also be located on the Remote Server 700. If this module determines that there is a match, the information corresponding to the media file is returned (e.g. a unique identifier for the media file is returned). This unique identifier may used to modify the playlist element and/or utilized by the Query the Local Media Database Component 507.

The Query the Local Media Database Component 507 may be configured or programmed to utilize the unique identifier or related information returned based on matches of the element in the playlist with Identification Database 1010 entries. If there is a match, then this component determines the file location of the appropriate media file, which may then be used by the Insert the Local Media Data Component 508. If a match is not found, then in one embodiment no information for this element is utilized by the Insert the Local Media Data Component 508. The Insert the Local Media Data Component 508 may be configured or programmed to modify, edit, or create a playlist the contains the local media file information (such as the file location) that was matched in the Local Media Database 603. In some embodiments, this modified, edited, or created playlist may be stored in the Local Playlist Database 602. The modified, edited, or created playlist may then be moved by the Move Module 405. FIG. 5A also illustrates at least some of the external files and databases that the Match Module may communicate with.

As will be understood by those of skill in the art, various functions described herein, such as parsing file names, identifying various file information, querying databases, storage and the like, and modifying electronic file information are particularly well, or exclusively, performed by computing devices programmed with special instructions related to these functions. In this regard, although such functions may be initiated, or otherwise managed, by human interaction, automated systems including computer microprocessors will be able to recognize, and alter, data that human beings are simply incapable of interacting directly with, such as electronic program files and file identification information. Thus, the use of specifically programmed computing devices is contemplated as a preferred embodiment for features described herein, including transforming electronic file information stored on computer readable storage media from one state to another, and processing queries of such information.

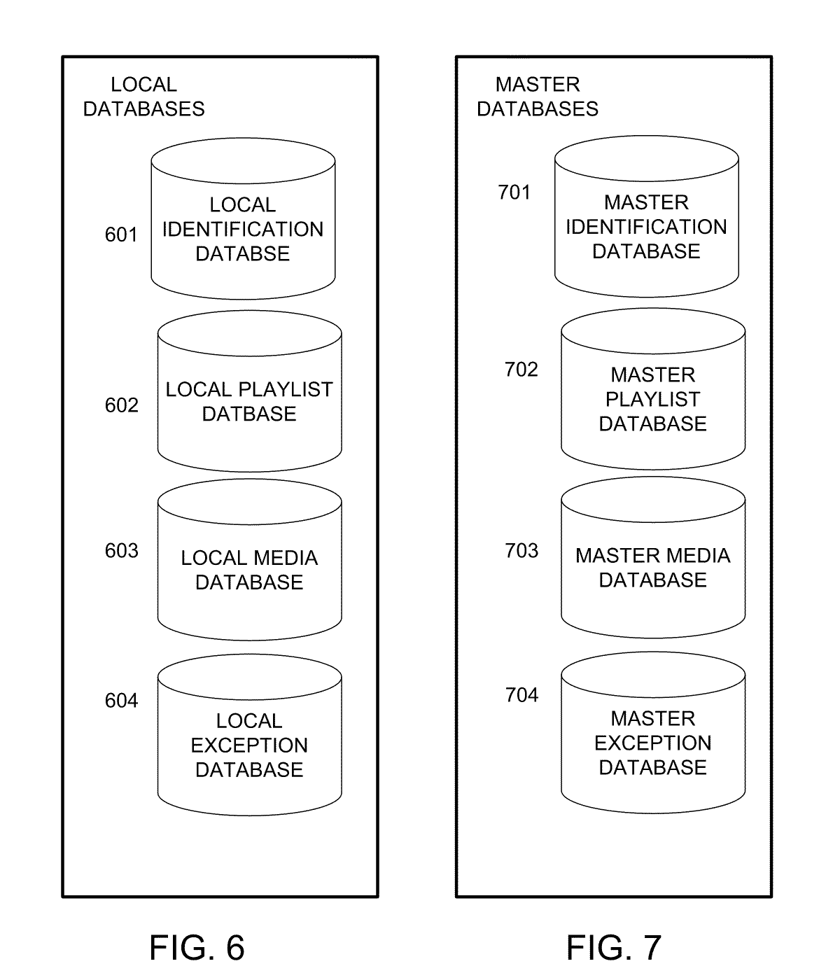

FIG. 6: Local Databases:

The Local Identification Database 601 may be configured to contain the most used and popular media identifiers. For music files, this may include popular artist and song title sets. The Local Identification Database 601 may be a subset of the Master Identification Database 701 that is based on user preferences, based on user information, based on other data such as media popularity in general, or any combination thereof. The information in the Local Identification Database 601 may be used to recognize songs on the hard drive and in playlists in an initial search that may be performed more quickly than a remote query to the master database.

The Local Playlist Database 602 may be configured to contain a standardized copy of all playlists on a digital media device, such as a PC. It may also contain an indicator for each playlist as to whether it is local only or shared, and which local digital media players have a copy. The Local Playlist Database 602 may also contain elements of playlist that did not have a corresponding match in the Local Media Database 602.

The Local Media Database 603 may be configured to contain a fully qualified file name and the reference number (e.g. unique identifier) of digital media files that are stored on the device and that have corresponding references in the Master Identification Database 701, such as shown in FIG. 7. For example for music files, the Local Media Database 603 may reflect the fully qualified file name and the reference number of every song that is identified in the device and corresponding to a song in the Master Artist and Song Title Database. This may be created or updated dynamically, periodically, upon request, and/or in response to an event (such as downloading or side-loading a new playlist).

The Local Exception Database 604 may be configured to contain all songs and playlist entries that cause exceptions. For digital music files as an example, an exception may include (1) song not found in an identification database (e.g. the Local 601 and Master 701 Identification Databases), (2) artist not found but song title is, (3) artist missing but song title is found, (4) playlist entry not found in databases, (5) songs in “Complete My Playlist” list not found in database, and (6) song in “Complete My Playlist” list not available for purchase. This database may be used as a local store of errors.

FIG. 7: Master Databases:

The Master Identification Database 701 may be configured to contain the full set of media identifiers, such as for digital music file artist and song title sets. The Master Identification Database 701 may be utilized to recognize media files on the hard drive and in playlists in the event that an initial search has failed to recognize the song in question.

The Master Playlist Database 702 may contain a standardized copy of all playlists that have been shared and are available for download. A playlist may be uploaded to this database from a users' local PC or other electronic device. A playlist may be downloaded from this database to the local playlist database on a users' local PC or other electronic device. This database may, for example, contain all playlist shared between all users of a playlist sharing service. The playlists contained in this database may already have been modified with information (such as a unique identifier) from an Identification Database 1010 or alternatively may still reflect the local file names from the PC or other electronic device that uploaded the playlist. In embodiments, a server-accessible database, such as Master Playlist Database 702, may be provided that contains only playlists that have been pre-formatted for use in multiple media applications through the use of client-side operations, such as match and move functions described herein.

The Master Media Database 703 may contain all digital media identifying information. For instance, Master Media Database 703 may include information related to every users' local media. This information may be queried using a computer processor and then used to recognize media files, such as songs, on the hard drive and in playlists. In alternative embodiments, a Master Database may include information for identifying other media files, such as actor, music video, television, film, or other title information. This database may provide users or PCs with information on which media files listed in a playlist are locally stored on the PC. This may have provide an additional benefit of informing a user of which playlists coincide with their current digital media files, which media files he may wish to purchase, and may reduce the risk of purchasing media files that the user already has locally stored.

The Master Exception Database 704 may contain all songs and playlist entries that cause exceptions. As an example, for digital music files an exception may include (1) song not found in an Identification Database 1010 (e.g. the Master Artist and Song Title Database), (2) artist not found but song title is, (3) artist missing but song title is found, (4) playlist entry not found in databases, (5) songs in “Complete My Playlist” list not found in database, and (6) song in “Complete My Playlist” list not available for purchase. This database may be used as a master store of errors that occur in the system and may be used by the system administrator to discover and correct system errors.

FIG. 8 depicts an exemplary embodiment in which a PC is optionally connected to Remote Server 700, such as a master server. Embodiments of the present invention may utilize both local and master databases to perform the programmed and configured functions. The master databases 701, 702, 703, 704 may be remote databases that may be connected to a PC or other electronic device by an Intranet or the Internet and contain a larger amount information regarding media files and playlists than the local databases 601, 602, 603, 604. However, it is also possible that storage capacities may allow a master database to be stored locally and updated periodically. In such an embodiment, the Match Module or programmed process may first query the “Local identification Database” that may contain less information and thus provide faster searching. If a match was not found in this database, a search may then be conducted on the “Master Identification Database” that contains additional information on more media files.

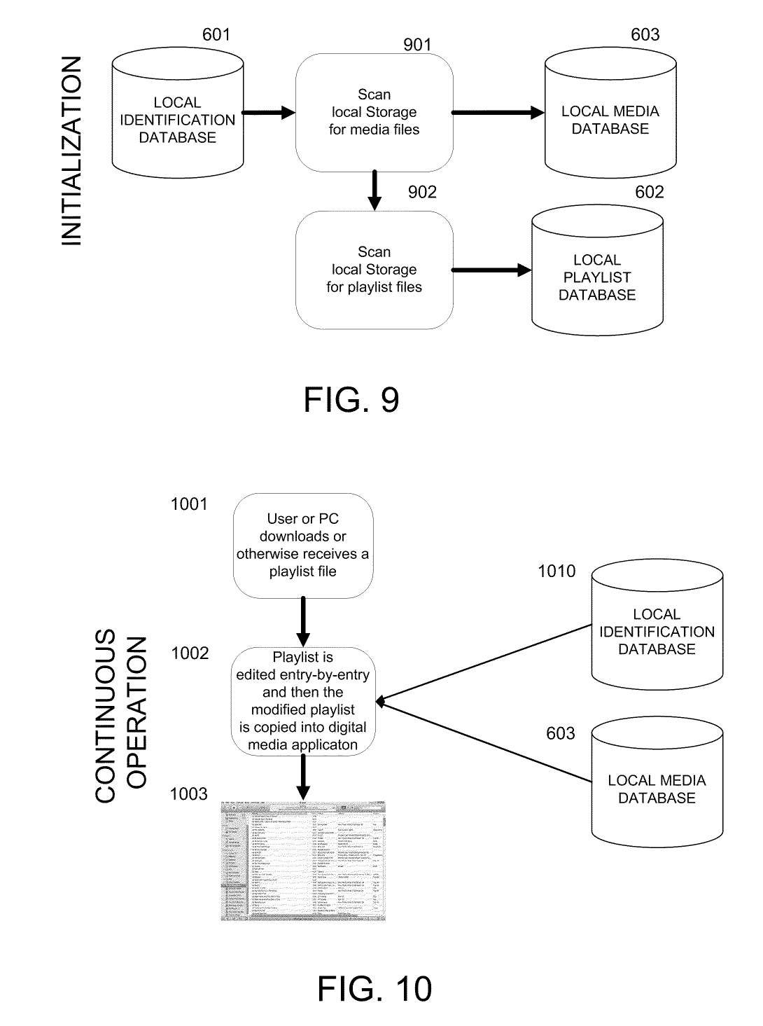

FIG. 9 depicts a flowchart of an initialization process for embodiments of the system and method related to the creation of the Local Media Database 603 and identification of local playlists. This depiction may also be related to embodiments of the configuration or programming of the Media Collection Scanning Module 401 and the Playlist Collection Scanning Module 402, which may provide similar functionality. Prior to step 901, the system or method is typically initiated by various events and/or means. This may be based on a periodic update (for instance once a week the system or method updates the Local Media Database 603), a request, an event (such as the download or side-load of a playlist), or other trigger.

At step 901, a Local Media Database 603 may be created. The local storage of a PC may be scanned for media files. For instance, the system or method may be configured or programmed to scan local memory, such as a local hard drive(s). Any media files that are found can then be identified by querying an Identification Database 1010 (or databases) utilizing components of the media file, such as the file names, or other identifying information (including any information extracted from related meta-data). When a local media file is matched to an entry in an identification database, information corresponding to that match may be returned (i.e. a unique identifier). This matching may utilize a search algorithm similar to the one utilized by the Matching Module 404. The media file along with the corresponding information received from the identification database is stored in the Local Media Database 603.

At step 902, the Local Playlist Database 602 may be created. A scan may be performed of the local storage for playlist files. For instance, the system or method may be configured to scan the local memory, such as a local hard drive(s), and create a Local Playlist Database 602. The Local Playlist Database 602 may then be used to access and manage the local playlists. This module may be used to initially create the local media database, and also to update the database periodically, upon request, or based on an event. An event may include, for example downloading a playlist from a remote server or side-loading a playlist from another local device.

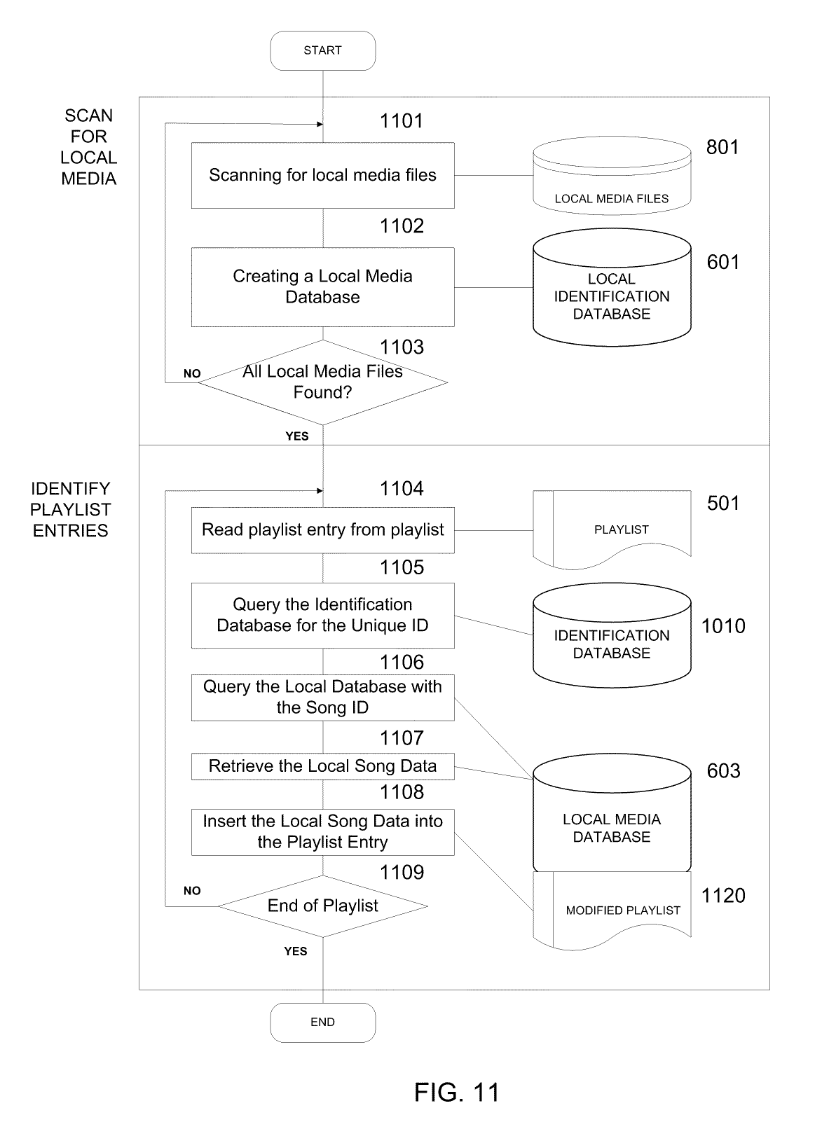

FIG. 10 depicts a flowchart of a process for continuous operation in accordance with an embodiment of the present invention. At step 1001, a user or PC receives a playlist file (for instance by downloading or side-loading). At step 1002, each entry in this playlist may then be modified or edited to contain information on the location of a corresponding local media file in local memory. After the playlist entries have been edited to reflect the location of the local media files, at step 1003 the modified or a new playlist may be moved to the appropriate storage location or directory to permit use by an appropriate digital media application. In this regard, the move module 405 may be configured according to predefined or acquired data regarding a digital media application that has been, for example, automatically detected, or selected by a user. The modified playlist may then be graphically displayed to the user by the designated digital media application.

At step 1002, if the received playlist file does not initially contain information retrieved from an Identification Server 1010 corresponding to the elements in the playlist (i.e. the unique identifier associated with that media file has not been linked to the playlist element), this information may be obtained by querying an Identification Database 1010. This may include querying the Identification Database 1010 using information for an element in the playlist file and identifying a match of a related media file. A unique identifier corresponding to that match is then received and utilized to identify a corresponding local media file on the PC. The location of this local media file is then utilized to edit the element of the playlist at 1002.

FIG. 11 depicts a flowchart of the operation of an exemplary embodiment of the present invention related to scanning for local media files and identifying elements of a playlist. At step 1101, a scan is conducted for local media files 801. For instance, the system or method may be configured or programmed to scan the contents of a media player database and/or scan local memory, such as a local hard drive(s). When a media file is found in, and/or referred to in, a media player database and/or local storage, the process moves to step 1102. At step 1102 the media files that are found are identified by querying a Local Identification Database 601 utilizing components of the media file, such as the file name, or other identifying information (including any information extracted from related meta-data). Alternatively, or in addition to, a Master Identification Database 701 located on a Remote Server 700 could also be utilized. In another embodiment, the Local Identification Database 601 is updated by the Master Identification Database 701 periodically, based on a request, or dynamically based on an event (such as a transfer of a playlist).

When a local media file is matched to an entry in an identification database, information corresponding to that match may be returned (i.e. a unique identifier is returned). This matching may utilize a search algorithm similar to the one utilized by the Matching Module 404. The media file along with the corresponding information received from the identification database is stored in the database, which may become the Local Media Database 603. The process then proceeds to step 1103. At step 1103, it is determined whether there are any more local media files. This may be done by scanning any remaining local storage areas. If there remain further media files, the process returns to step 1101. If all media files have been identified, the process moves to step 1104. An alternative to the this embodiment may include searching the local storage area for all media files at step 1101, identifying all local media files utilizing the process involving an Identification Database without performing additional searches for further media files, and after all local media files are identified and stored in the Local Media Database, proceeding to step 1104.

At step 1104, a playlist entry is read from the playlist file 501. This may include parsing information to determine pre-designated data of significance, such as, taking the example of digital music files, the artist and song title for each entry in the playlist. This information may then be used at step 1105 to query an Identification Database 1010 to return information corresponding to a media file referenced by the element in the playlist. The Identification Database 1010 could be a Local 601 or a Master 701 Identification Database, or a combination thereof. If a match of the element in the playlist is found with an entry in the Identification Database 1010, a unique identifier or other related information corresponding to the designated media file is returned. The process then moves to step 1106 where this returned information (e.g. unique identifier) is used to query the Local Media Database 603. If there is match of this received information from the Identification Database 1010 and a Local Media File 801, the local media file information (such as file location) is then returned at step 1107. At step 1108, the file location and/or other information related to the local media file is inserted into the playlist entry. At step 1109, it is determined whether this is the last element in the playlist. If so, the process may terminate. If not, then the process returns to step 1104.

Following step 1109, embodiments may permit the issuance of a report on the results of the process. This report may include information on the number of playlist elements that correspond to local media files and/or additional information on those elements; the number of elements in the playlist that did not correspond to local media files and/or additional information on those elements, the number of playlist elements that could not be identified by the Identification Databases and/or additional information on those elements. Furthermore, for any elements in the playlist that were identified using the Identification Database 1010 but were not matched to a media file on the playlist, the user may be given the option to purchase these media files.

FIG. 12 depicts a flowchart operation of an exemplary embodiment of the present invention related to identifying playlist entries. At step 1201, a playlist entry is read from the Playlist File 501. This may include parsing information to determine pre-designated data of significance, such as, taking the example of digital music files, the artist and song title for each entry in the playlist. This information may then be used at step 1202 to query a Local Identification Database 601. At step 1203, it is determined whether there is a match to the element in the playlist in the database. If yes, then identification information is returned from the Local Identification Database 601 corresponding to a media file referenced by the element in the playlist and the process moves to step 1206. If no match is found, then the process proceeds to step 1204.

At step 1204, the Master Identification Database 701 is queried using the parsed or other information corresponding to the element in the playlist. At step 1205, it is determined whether this information is a match to any of the media file information listed in the Master Identification Database 701. If there is a match, the process proceeds to step 1206. If there is no match in the Master Identification Database, then the process may send an exception code and the original playlist entry to an Exception database (which could include a Local 604 or Master 704 Exception Database). Additionally, in an embodiment of the present invention, there is no information entered in the modified or edited playlist corresponding to that particular element in the Playlist File 501. Thus, subsequently when the modified playlist is moved to the proper local directory or file location, that entry may remain in the Local Playlist Database 602. Alternatively, this data may be flagged or commented out of the playlist.

If the process enters step 1206, then a match was found in at least one of the Identification Databases for the element in the playlist. The process then uses reference information corresponding to that match that was received from the Identification Database to query the Local Media Database 603. If there is a corresponding match found in the Local Media Database 603 based on the information received from the Identification Database, then the process moves to step 1207. If there is not a corresponding match in the Local Media Database 603, then the process may issue an exception code and send this along with the original playlist entry to a Local 604 or Master 704 Exception Database. Alternatively, the user may also have the option to purchase the media file. Additionally, no information is entered into the modified playlist for this entry. Alternatively, a flag indicates that this play list entry did not have a corresponding media file on the local PC.

At step 1207, the process edits the playlist element by inserting the file fully qualified string into the playlist at this entry (or any other information about the local media file location). At step 1209, the process determines if this is the last element in the playlist. If it is, then the process terminates. If it is not, then the process returns to step 1201.

FIG. 13 depicts a flowchart of a playlist download in accordance with an embodiment of the present invention. At step 1301, a playlist is downloaded to a PC. Alternatively, a playlist could also be side-loaded from another local device or any other method of transferring an electronic file. In this embodiment, it may be presumed that the elements in the playlist have been identified and associated with unique information corresponding to a related media file. Thus, there is no need to perform the querying of an Identification Database 1010. Instead, the next step in the process at 1303 is to determine if each element in the playlist corresponds to a media file locally stored on the device. This may require utilizing the unique information associated with the elements in the playlist to query the Local Media Database 603 and identify any matches. If a match is found, at 1304 the element in the playlist is updated or modified to reflect the file location of the associated local media file. If an element in the playlist does not have a local media file match, then at 1305 the playlist may be edited to remove the element. Alternatively, such elements could be flagged as not corresponding to a local match or, no data may be entered into that element of the playlist. At 1306 the process determines if there are any more playlist entries. At 1307, the edited or modified playlist may be automatically converted, with no need for user input, to match a local media player specific format. Finally, at 1308 the modified playlist may be automatically moved or copied to a playlist folder or into a Playlist Database. Also, the modified playlist may be moved to a drive or file location that is required for operation with a specific local media player application.

An alternative embodiment disclosed in FIG. 13 involves matching the elements in the playlist directly to the file name of the locally stored media file. Again, there is no requirement in this process of querying an Identification Database 1010. Instead at step 1303, both the elements in the playlist and the local media file names are parsed and/or standardized. This parsed and/or standardized information is compared using a search or match algorithm to determine if any correspond to the same media file.

FIG. 14 depicts a process of a playlist upload in accordance with an embodiment of the present invention. This may encompass a situation in which a user that creates a playlist for use by other users, other PCs, any other digital media player application, or to share and store on a remote server. At step 1401, a playlist is created. At step 1402, the process determines if this playlist is in a standardized format. A playlist in standardized format may be much faster and more accurately matched to database elements. If the playlist is standardized, the process moves to step 1404. If it is not standardized, the process moves to step 1403. At step 1403 the playlist is standardized according to a predefined standard based on such factors as the type of media file, the parameters of the search algorithm, etc. Alternative embodiments may match on parsed inflammation of the playlist elements without standardization.

At step 1404, an element of the playlist is read. At 1405, an Identification Database (which could include either a Local 603 or Master 703 Identification Database, or a combination thereof) is queried to match the standardized information for the element of the playlist. If a match is found, the process moves to step 1406 wherein the information related to that matched media file is added to the playlist entry (i.e. the unique identifier is now included in the playlist entry). If a match is not found in the Identification Database 1010, then the process moves to step 1408, where the process may send an exception code and the original playlist entry to an Exception Database (which could include a Local 604 or Master 704 Exception Database). The process then proceeds to step 1407 and determines if there are any more elements in the playlist. If not, the output of the process is a standardized playlist where the elements in the playlist that correspond to identified media files include a unique identifier for that file. Thus, any use by this outputted playlist by a different PC, user, digital media application platform, etc. will only be required to match its locally stored media files to the unique identifiers included in the playlist.

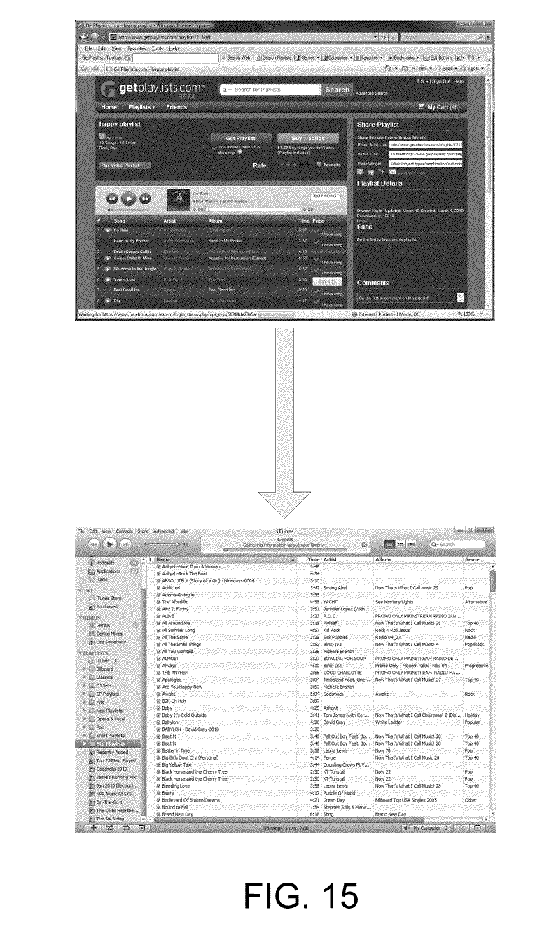

FIG. 15 depicts a graphical user interface and related functionality that is in accordance with an embodiment of the present invention. Specifically, a user may visit a website and download a desired playlist. The selected playlist may then automatically downloaded to the PC and into a digital media platform (such as iTunes®). In this example, the PC downloads a playlist to a preinstalled application on the user's PC (which may include the PC Modules 401-405 or a combination thereof), which then performs the matching of the playlist with the local media files. This application may then automatically insert the playlist into the digital media software platform, without requiring further interaction by the user.

Although described in the context of software for exemplary purposes, it will be understood by one of ordinary skill in the art that such software instructions may be, and typically are, recorded on computer-readable storage media. Such media may include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as optical disks; and hardware devices that are specially configured to store and perform program instructions, such as read-only memory devices (ROM) and random access memory (RAM), such as magnetic, optical, and assorted discs, and solid state memory.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method comprising:
electronically scanning a local storage for media files;
automatically creating a local media database based on the scan;
identifying a playlist;
automatically identifying a media file in the local media database corresponding to an element in the playlist; and
automatically updating the element in the playlist based on the identified media file.

2. The method of claim 1, wherein said step of automatically updating the element in the playlist comprises changing a file identifier of the playlist to a second file identifier that (a) corresponds to a media application that the playlist was not created by, (b) is located on a device that the playlist was not created on, or (c) corresponds to a new file location on a device that the playlist was created on.

3. The method of claim 1, further comprising:
electronically querying an identification database based on the element in the playlist;
receiving information from the identification database corresponding to the element in the playlist;
wherein the step of automatically identifying a media file in the local media database further comprises utilizing said received information from said identification database.

4. The method of claim 3, wherein said identification database is a local identification database and is customized based on user preferences, media popularity, or some combination thereof.

5. The method of claim 3, wherein said identification database is a master identification database.

6. The method of claim 3, wherein querying the identification database further comprises:
querying a first identification database based on the element in the playlist;
if a first match of the element in the playlist is identified in the first identification database:
utilizing information corresponding to said first match as the received information for automatically identifying a media file in the local media database;
if a first match of the element in the playlist is not identified in the first identification database:
electronically querying a second identification database based on the element in the playlist;
receiving information corresponding to a second match of the element in the playlist in the second identification database; and
utilizing said information corresponding to said second match as the received information for automatically identifying a media file in the local media database

7. The method of claim 6, wherein said first identification database is a local identification database, and said second identification database is a master identification database.

8. The method of claim 1, wherein said step of automatically identifying a media file in the local media database comprises:
utilizing information from an identification database,
wherein said information was obtained by an electronic query of said identification database based on the element in the playlist, and
wherein said query was performed by a computing device that did not automatically create the local media database based on the scan.

9. The method of claim 8, wherein the electronic query of the identification database comprises:
querying a first identification database based on the element in the playlist;
if a first match of the element in the playlist is identified in the first identification database:
utilizing information corresponding to said first match as the information for automatically identifying a media file in the local media database;
if a first match of the element in the playlist is not identified in the first identification database:
electronically querying a second identification database based on the element in the playlist;
receiving information corresponding to a second match of the element in the playlist in the second identification database;
utilizing said information corresponding to said second match as the received information for automatically identifying a media file in the local media database.

10. A system comprising:
an electronic storage device including stored media files;
a media collection scanning module configured to scan the storage device, identify the stored media files, and create a local media database;
a playlist module that is configured to identify a playlist;
a match module that is configured to match an element in the playlist with a media file in the local media database;
a move module configured to move the playlist to an appropriate storage location for either a media application that the playlist was not created by or a device that the playlist was not created on.

11. The system of claim 10, wherein the match module is further configured to match an element in the playlist with a media file in the local media database based on information received from an identification database.

12. The system as recited in claim 11, wherein the identification database is an Internet or Intranet based master identification database or a local identification database.

13. The system of claim 12, wherein the match module is further configured to match an element in the playlist with a media file in the local media database based on standardized identification information in the identification database.

14. The system of claim 11, wherein the match module is further configured to:
query a local identification database based on the element in the playlist;
if a first match of the element in the playlist is identified in the local identification database:
utilize information corresponding to said first match to match the element in the playlist with a media file in the local media database;
if a first match of the element in the playlist is not identified in the local identification database:
query a master identification database based on the element in the playlist;
identify a second match of the element in the playlist in the master identification database;
utilize information corresponding to said second match to match the element in the playlist with a media file in the local media database.

15. The system as recited in claim 10, wherein the playlist module is further configured to standardize a non-standard formatted playlist element and parse a standardized playlist element.

16. The system as recited in claim 10, wherein the match module is configured to match a component of a playlist element to a media file in the local media database.

17. The system as recited in claim 10, wherein the match module is configured to match a playlist element having errors to a media file, wherein said errors include any of the following: incomplete artist or song title, incomplete component of a playlist element, mis-spellings, typos, transpositions, abbreviated spellings, acronyms, or any combination thereof.

18. The system as recited in claim 10, wherein the match module is further configured to match a playlist element that has a missing or incorrect internal tag to a media file.

19. The system as recited in claim 10, wherein the match module is configured to edit a playlist element that matches a local media file to the drive letter, fully qualified path, file name, extension, or any combination thereof.

20. The system as recited in claim 10, wherein the move module is configured to only move a playlist entry that matches a local media file.

21. A computer-readable storage medium bearing instructions that, when executed by a computer, cause the computer to:
scan a local storage for media files;
create a local media database based on the scan;
identify a playlist;
query a local identification database based on an element in the playlist;
if a first match of the element in the playlist is identified in the local identification database:
query the local media database based on information in the local identification database that corresponds to said first match; and
identify media files in the local media database that correspond to the information in the local identification database that corresponds to said first match;
if a first match of the element in the playlist is not identified in the local identification database:
query a master identification database based on the element in the playlist;
identify a second match of the element in the playlist in the master identification database,
query the local media database based on information received from the master identification database that corresponds to said second match; and
identify media files in the local media database that correspond to the information received from the master identification database;
update the playlist element based on the identified media files; and
change a file identifier of the playlist to a second file identifier that (a) corresponds to a media application that the playlist was not created by, or (b) is located on a device that the playlist was not created on.

22. The computer-readable storage medium of claim 21, further comprising instructions that when executed cause a computer to send an exception code and the element of a playlist to an exception database if a first match of the element in the playlist is not identified in the local identification database and a second match of the element in the playlist is not identified in the master identification database.

23. The computer-readable storage medium of claim 21, further comprising instructions that when executed cause a computer to provide an option to purchase a media file if a second match of the element in the playlist is identified in the master identification database but no media files are identified in the local media database that correspond to information received from the master identification database that corresponds to said second match.

24. The computer-readable storage medium of claim 21, further comprising instructions that when executed cause a computer to provide a report to a user of how many of the elements of a playlist were identified in the local media database, how many of the elements of the playlist were not identified in the local media database, or a combination thereof.
